(19) United States
(12) Patent Application Publication
(10) Pub. No.: US 2016/0172069 A1
(43) Pub. Date: Jun. 16, 2016

(54) CONTACT TERMINAL STRUCTURE

(71) Applicant: KANZACC CO., LTD., Osaka (JP)

(72) Inventors: Yoshinori SUMIYA, Osaka (JP); Isao SEGAWA, Osaka (JP)

(21) Appl. No.: 14/897,604

(22) PCT Filed: May 29, 2014
(86) PCT No.: PCT/JP2014/064308

§ 371 Date: Dec. 10, 2015

(30) Foreign Application Priority Data
Jun. 11, 2013 (JP) 2013-122755

(51) Int. Cl. H01B 1/02; B32B 15/01

(52) U.S. Cl. CPC H01B 1/02; B32B 15/018

(57) ABSTRACT

A contact terminal structure includes: a first plating layer formed on a surface of a substrate; and a second plating layer formed on a surface of the first plating layer as an outermost layer, in which the first plating layer is composed of a silver-tin alloy, the second plating layer is silver plating or an alloy essentially consisting of silver, the first plating layer has a hardness greater than the second plating layer, and the first plating layer has a Vickers hardness of 250 to 400 and the second plating layer has a Vickers hardness of 80 to 200.

### CROSS-REFERENCE TO RELATED APPLICATION

This application is a U.S. National stage application of International Application No. PCT/JP2014/064308, filed May 29, 2014, which claims priority to Japanese Patent Application No. 2013-122755 filed on Jun. 11, 2013. The entire disclosures of Japanese Patent Application No. 2013-122755 are incorporated by reference herein.

### BACKGROUND

1. Field of the Invention

The present invention relates to a contact terminal structure in a contact terminal for electric parts such as a relay (for instance, a power relay for an electric automobile), a switch, a connector, and a breaker. More particularly, the present invention relates to a contact terminal structure in a movable contact terminal.

2. Background Information

Generally, it is important for a contact terminal or a slide switch terminal in a plug, a jack, a connector and a relay, which enables an electric connection by inserting a plug, to have higher electrical conductivity and smaller contact resistance.

Contact terminal structures including contact terminal materials have been improved to obtain such contact terminals that are superior in electrical connectivity.

Typically, Japanese Patent Application Publication No. 2012-124112 A discloses a fretting phenomenon-compliant contact in which the plating thickness of a first contact part is different from the plating thickness of a counterpart second contact part.

Japanese Patent Application Publication No. 2011-198683 A discloses a connection terminal for connector in which a silver-tin alloy coating portion is formed in a terminal portion as a terminal which can be inserted and removed with a low frictional force as well as excitation of superior electric characteristics as a conductive material.

Further, Japanese Patent Application Publication No. 2012-119308 A discloses a low cost silver plating material, in which an underlayer composed of Ni is formed on a surface of a material composed of stainless steel, a middle layer composed of copper is formed on the underlayer, and a surface layer composed of silver is formed on the middle layer, which enables to control an increase in contact resistance of plating and is useful as a material for a contact such as a connector, a switch, and a relay and terminal parts.

Japanese Patent Application Publication No. 2012-226994 A discloses a connector structure, in which a plating layer composed of an alloy of silver and tin is formed on a surface of a contact connection portion and the alloy has a tin content ratio of 5 weight % to 30 weight %, which has low contact resistance and superior durability.

However, contact resistance increases due to repeated on-off operation. This is greatly caused by abrasion of a contact terminal material used for a contact terminal. As hardness of the contact terminal material increases, less abrasion becomes. Such a material is, however, not suitable for a contact terminal material because the material generally has low electrical conductivity.

### SUMMARY

It is an object of the present invention to provide a contact terminal structure having superior durability which prevents an increase in contact resistance even when on-off operation is repeated in the case where the contact terminal structure is applied to a movable contact terminal.

In a first preferred aspect, there is provided a contact terminal structure according to the present invention which includes: a first plating layer formed on a surface of a substrate; and a second plating layer formed on a surface of the first plating layer, the first plating layer is composed of a silver-tin alloy, the second plating layer is composed of silver plating or an alloy essentially consisting of silver, and the first plating layer has a hardness greater than the second plating layer. The difference in hardness makes the second plating layer softer than the first plating layer.

In a second preferred aspect of the contact terminal structure according to the present invention, the first plating layer has a Vickers hardness of 250 to 400 and the second plating layer has a Vickers hardness of 80 to 200.

In a third preferred aspect of the contact terminal structure according to the present invention, when P is a thickness of the first plating layer and Q is a thickness of the second plating layer, Q/(P+Q) is 0.07 to 0.4.

In a fourth preferred aspect of the contact terminal structure according to the present invention, Q/(P+Q) is more preferably 0.15 to 0.25.

When the contact terminal structure of the present invention is applied to a contact terminal, the contact terminal structure has superior durability which prevents an increase in contact resistance even when on-off operation is repeated by making the hardness of the first plating layer greater than the hardness of the second plating layer.

### BRIEF DESCRIPTION OF THE DRAWINGS

Referring now to the attached drawings which form a part of this original disclosure.

FIG. 1 is a schematic view of a plating structure in a contact terminal structure of the present invention;

FIG. 2 is a schematic view showing a method for measuring contact resistance values of the present invention;

FIG. 3 is a chart showing a relation between the number of sliding cycles and contact resistance of the contact terminal structure;

FIG. 4 is a chart showing a relation between the number of sliding cycles and contact resistance of the contact terminal structure;

FIGS. 5(a) to 5(c) illustrate study of abrasion of metals, in which FIG. 5(a) is a schematic view of soft metal only, FIG. 5(b) is a schematic view of hard metal only, and FIG. 5(c) is a schematic view of a soft metal layer formed on hard metal.

### DESCRIPTION OF THE PREFERRED EMBODIMENTS

A contact terminal structure of the present invention will now be described using drawings. A contact terminal structure of the present invention is applied to a terminal such as a switch contact or a connecter that repeats on-off operation. The contact terminal structure of the present invention may be applied to both a male terminal and a female terminal.

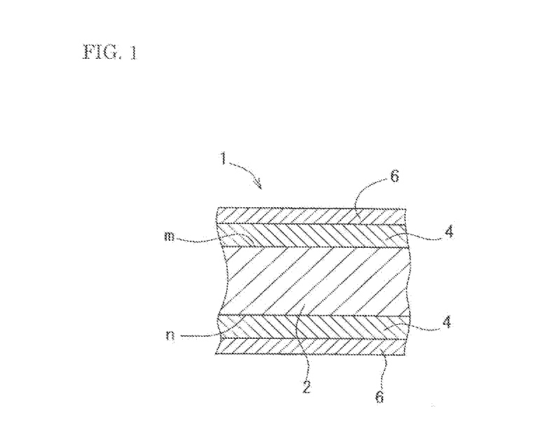

As shown in FIG. 1, a contact terminal structure 1 of the present invention includes: a substrate 2 composed of metal; a first plating layer 4 formed on a surface of the substrate 2; and a second plating layer 6 formed on a surface of the first plating layer 4. The first plating layer 4 and the second plating layer 6 are laminated on a surface of the substrate 2 in order.

The substrate 2 forms either shape or both shapes of a male terminal and a female terminal. The substrate 2 is preferably composed of metal essentially consisting of copper or a copper alloy in view of conductivity and cost. The metal of the substrate 2 may be changed to the other metal, as long as the metal can be used as a metal terminal. The surface of the substrate 2 may be substrate treated such as nickel plating to form the first plating layer 4.

The first plating layer 4 is composed of a silver-tin alloy. The second plating layer 6 is silver plating or an alloy essentially consisting of silver. The first plating layer 4 has a greater hardness than the second plating layer 6. The hardness of the plating layer is the hardness of metal included in the layer.

According to the configuration of the present invention, when the contact terminal structure 1 is rubbed, rubbing is conducted by a solid lubricant. The second plating layer 6 functions as a solid lubricant. As a result, frictional resistance is minimized and wear caused by friction becomes smaller.

It is preferable to select the composition ratio between silver and tin in the silver-tin alloy of the first plating layer 4 in the range of 250 to 400 of a Vickers hardness (Hv(kgf/mm²)) of the silver-tin alloy that forms the first plating layer 4.

When the first plating layer 4 has a Vickers hardness of 250 to 400, the second plating layer 6 preferably has a Vickers hardness of 80 to 200. The second plating layer 6 is softer than the first plating layer 4.

The aforementioned Vickers hardness enables the first plating layer 4 to have smaller wear caused by repeated sliding than the case where the first plating layer 4 has a Vickers hardness of less than 250, resulting in preferable durability. In this case, the first plating layer 4 preferably has smaller wear when sliding repeatedly increases than the case where the first plating layer 4 has a Vickers hardness of over 400, which is high.

In the case where the second plating layer 6 has a Vickers hardness of 80 to 200, the second plating layer 6 has smaller wear caused by repeated sliding than the case where the second plating layer 6 has a Vickers hardness of less than 80 when the first plating layer 4 has a Vickers hardness of 250 to 400. As a result, contact resistance does not immediately increase by repeated sliding, which is preferable. Compared with the case where the second plating layer 6 has a Vickers hardness of over 200, which is high, wear caused by repeated sliding is small, so that contact resistance values preferably become lower.

It is possible to set the composition ratio of silver and tin in a silver-tin alloy which forms the first plating layer 4 by setting the ratio of silver salt and tin salt in a plating bath at a predetermined value. Accordingly, each kind of plating layer is formed by gradually changing the proportion of silver salt to tin salt in the plating bath to measure the hardness of the silver-tin alloy that forms a plating layer in each composition. This makes it possible to obtain a proportion of silver salt to tin salt in the plating bath which can form the first plating layer 4 having a Vickers hardness of 250 to 400.

The silver alloy of the second plating layer 6 may contain components other than silver. It is preferable to select the composition ratio of the components other than silver in the range of a Vickers hardness (kg mm²) of 80 to 200. Examples of components contained in a silver alloy other than silver include at least one kind selected from selenium, antimony. These components are preferably used as components for a brightener.

It is possible to set the composition ratio of silver to metal other than silver in a silver alloy contained in the second plating layer 6 at a proportion of silver salt to metal salt other than silver in the plating bath. The proportion of silver salt to metal other than silver is gradually changed to form each kind of plating layer and measure the hardness of metal that forms a plating layer in each composition. This enables to obtain the proportion of silver salt to metal other than silver in the plating bath that can form the second plating layer 6 having a Vickers hardness of 80 to 200.

It is also possible to obtain the second plating layer 6 by forming a plating layer using a plating bath in which one or plural kinds of brighteners are contained. Also in this case, the content ratio of a brightener in the plating bath is gradually changed or the kind of brightener is changed to form each kind of plating layer and measure hardness of metal that forms a plating layer in each composition. This makes it possible to obtain a content ratio of the brightener contained in the plating bath that can form the second plating layer 6 having a specific hardness in the range of a Vickers hardness of 80 to 200. The brightener preferably includes a substance containing selenium or antimony (for instance, (Silver grow 3KBP (produced by Meltex Inc.)).

The first plating layer 4 and the second plating layer 6 are formed on the entire surface of the substrate 2. The substrate 2 may be partially plated by employing a plating resist. For instance, one surface m of the substrate 2 is plated and the other surface n is not plated by a plating resist. In addition, such plating may be in a stripe shape.

The first plating layer 4 preferably has a thickness of 0.4 μm to 50 μm. When the fist plating layer 4 has a thickness of greater than 50 μm, it takes too much time to form the first plating layer 4. When the first plating layer 4 has a thickness of smaller than 0.4 μm, the first plating layer 4 has no effect as an inner layer to be described below.

The second plating layer 6 preferably has a thickness of 0.04 μm to 6 μm. When the second plating layer 6 has a thickness of more than 6 μm, it takes too much time to form the second plating layer 6. When the second plating layer 6 has a thickness of smaller than 0.04 μm, a problem such as durability arises.

The thicknesses of the first plating layer 4 and the second plating layer 6 should be set appropriately in accordance with pressure when contact terminal kinds to be applied to the contact terminal structure 1 are used. Accordingly, it is generally preferable to set these thicknesses greater as the pressure is greater.

When the first plating layer 4 has a thickness P and the second plating layer 6 has a thickness Q in the range of the thicknesses of the aforementioned plating layers 4 and 6, it is preferable that Q/(P+Q) is 0.07 to 0.4 to obtain the contact terminal structure 1 having superior durability in which contact resistance does not easily increase even after repeated on-off operation. It is further preferable that Q/(P+Q) is 0.15 to 0.25 to obtain the contact terminal structure 1 having superior durability, in which contact resistance does not easily increase even after repeated on-off operation.

When the contact terminal structure 1 of the present invention is applied to a movable contact terminal, even when on-off operation is repeated, contact resistance does not easily increase. Minimizing the contact resistance makes it possible to minimize friction force, resulting in no increase in wear loss. Since materials having superior conductivity are used for the substrate 2 and each of the plating layers 4 and 6, there is no possibility of conductivity being deteriorated.

The present invention will now be described in detail using experimental examples.

Measurement of Contact Resistance Values

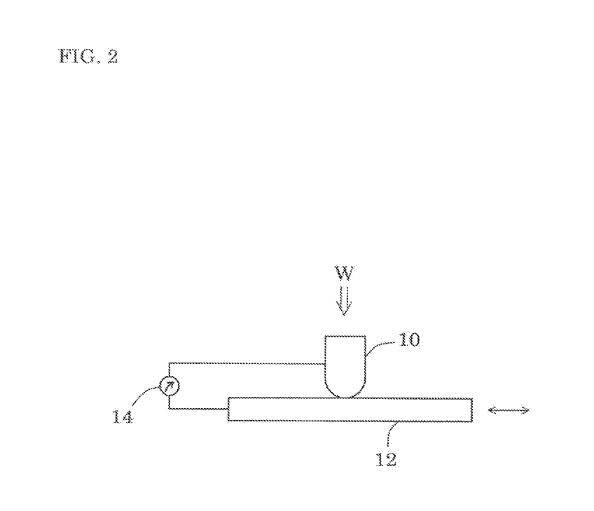

As shown in FIG. 2, a tip of a probe 10 was allowed to come into contact on an upper surface of a plate 12. A load W was applied from the probe 10 to the plate 12 to cause the plate 12 to swing (reciprocating motion). A resistance value measuring instrument 14 was used to measure contact resistance values between the plate 12 and the probe 10 at that time. The contact resistance values that vary in accordance with the number of oscillations were continuously recorded in a two-dimensional chart by using a recorder not shown showing the number of oscillations as a horizontal axis and the contact resistance values as a vertical axis.

In experimental examples, a contact terminal structure, in which each kind of plating structure composed of a one-layer plating layer or a two-layer plating layer is formed on a surface of the base as the plate 12, was used. A contact terminal structure, in which a plating structure that is the same as the counterpart plate 12 was formed on a surface of the base, was used as the probe 10.

The plate 12 was caused to swing side to side having an amplitude of 10 mm and at a speed of 30 mm/sec by use of an outermost layer of plating as an upper surface. Swinging of the plate 12 makes the tip of the probe 10 to relatively slide against the plate 12 while making the tip of the probe 10 contact with the plate 12. The load W applied to the probe 10 included 2 kinds: 30 gf; 300 gf. The tip of the probe 10 is in the shape of a hemisphere having 1.5 mmR and an outermost layer composed of plating forms a surface layer of the tip.

Sample

Base (substrate 2)

Substrate of a plate 12: copper plate Ni plated

Substrate of a probe 10: copper

Plating structure: measurements were made on hardness of an upper layer (a second plating 6) and a lower layer (a first plating layer 4) in a plating structure and the following measurement items for each kind of plating structure with a thickness of each layer changed (In the case where either of the layers has a thickness of 0, a plating layer which forms a plating structure is only one layer).

The hardness of the upper layer (the second plating layer 6) had two standards: 80, 180.

The hardness of the lower layer (the first plating layer 4) had two standards: 250, 330.

Plating Bath Used for Formation of a Plating Layer

Table 1 shows a composition of a plating bath in accordance with the hardness of the second plating layer 6. A plating bath based on this composition was used to perform plating by a conventional method. In two kinds of brighteners, an added amount was adjusted in the range of 1 to 20 mL/L so as to obtain a prescribed hardness.

TABLE 1

Hardness (Hv)

| | 80 | 180 |
|---|---|---|
| Potassium Ag cyanide (g/L) | 70 | 70 |
| Potassium cyanide (g/L) | 20 | 90 |
| Potassium carbonate (g/L) | 20 | 20 |
| Brightener | None | Silver Glo |
| | | 3KBP(produced by |
| | | Meltex Inc.) |
| | | Silver Glo TY |
| | | (produced by Meltex |
| | | Inc.) |

Table 2 shows one example of the composition of a plating bath of the first plating layer 4. A plating bath based on this composition was used to perform plating by a conventional method. As a result, a silver-tin layer having a tin composition ratio of 13 weight % was obtained as the first plating layer 4. The first plating layer 4 in this case has a hardness of 250.

TABLE 2

| | |
|---|---|
| Potassium Ag cyanide (g/L) | 40 |
| Potassium cyanide (g/L) | 100 |
| Tin (II) chloride dehydrate (g/L) | 10 |
| Caustic potash (g/L) | 20 |

Measuring Items

Contact resistance values at 6,000 cycles of sliding

Number of cycles at which contact resistance values rise sharply

Measurement Results

Tables 3 to 5 show measurement results. Such measurement results support effects of the present invention. In tables 3 to 5, “Excellent” means that a plating structure has extremely superior performance as a contact terminal structure. “Good” means that a plating structure has particularly superior performance as a contact terminal structure. “Unacceptable” means that a plating structure has superior performance as a contact terminal structure. “Bad” means that a plating structure has insufficient performance as a contact terminal structure.

TABLE 3

| Load W | | | Sample No. | | | | | | |
|---|---|---|---|---|---|---|---|---|---|
| (gf) | | | 1 | 2 | 3 | 4 | 5 | 6 | 7 |
| 300 | Plating | Thickness (μm) of | 0 | 0.5 | 1 | 2 | 3 | 5 | 10 |
| | structure | a second plating | | | | | | | |
| | | layer | | | | | | | |
| | | (hardness: 180) | | | | | | | |
| | | Thickness (μm) of | 10 | 9.5 | 9 | 8 | 7 | 5 | 0 |
| | | a first plating layer | | | | | | | |
| | | (hardness: 250) | | | | | | | |

| | | | | | | | |
|---|---|---|---|---|---|---|---|
| Contact resistance (mΩ) at the | 200 | 150 | 30 | 20 | 30 | 250 | 1,000< |
| time of 6,000 cycles of sliding | | | | | | | |
| Wear depth (μm) at the time of | 5 | 4 | 2 | 1.5 | 3 | 9 | 10 |
| 6,000 cycles of sliding | | | | | | | |
| Number of cycles (×1000) at | 3 | 4 | 6 | 6 | 5 | 4 | 1.5 |
| which contact resistance rises | | | | | | | |
| sharply | | | | | | | |
| Overall evaluation | Bad | Unaccept- | Good | Excel- | Good | Bad | Unaccept- |
| | | able | | lent | | | able |

| | | | Sample No. | | | | | |
|---|---|---|---|---|---|---|---|---|
| | | | 8 | 9 | 10 | 11 | 12 | 13 |
| 300 | Plating | Thickness (μm) of | 0.5 | 1 | 2 | 3 | 5 | 10 |
| | structure | a second plating | | | | | | |
| | | layer (hardness: 80) | | | | | | |
| | | Thickness (μm) of | 9.5 | 9 | 8 | 7 | 5 | 0 |
| | | a first plating layer | | | | | | |
| | | (hardness: 250) | | | | | | |

| | | | | | | |
|---|---|---|---|---|---|---|
| Contact resistance (mΩ) at the | 120 | 30 | 20 | 30 | 270 | 1,000< |
| time of 6,000 cycles of sliding | | | | | | |
| Wear depth (μm) at the time of | 4 | 2 | 1.5 | 4 | 9 | 10 |
| 6,000 cycles of sliding | | | | | | |
| Number of cycles (×1000) at | 4 | 6 | 6 | 5 | 4 | 1 |
| which contact resistance rises | | | | | | |
| sharply | | | | | | |
| Overall evaluation | Unaccept- | Good | Excel- | Good | Unaccept- | Bad |
| | able | | lent | | able | |

TABLE 4

| | | | Sample No. | | | | | | |
|---|---|---|---|---|---|---|---|---|---|
| | | | 1 | 2 | 3 | 4 | 5 | 6 | 7 |
| 30 | Plating | Thickness (μm) of a | 0 | 0.05 | 0.1 | 0.2 | 0.3 | 0.5 | 1 |
| | structure | second plating layer | | | | | | | |
| | | (hardness: 180) | | | | | | | |
| | | Thickness (μm) of a | 1 | 0.95 | 0.9 | 0.8 | 0.7 | 0.5 | 0 |
| | | first plating layer | | | | | | | |
| | | (hardness: 250) | | | | | | | |

| | | | | | | | |
|---|---|---|---|---|---|---|---|
| Contact resistance (mΩ) at the time | 250 | 140 | 40 | 25 | 38 | 320 | 1,000< |
| of 6,000 cycles of sliding | | | | | | | |
| Wear depth (μm) at the time of 6,000 | 0.5 | 0.4 | 0.2 | 0.15 | 0.32 | 0.88 | 1 |
| cycles of sliding | | | | | | | |
| Number of cycles (×1000) at which | 3 | 4 | 6 | 6 | 5 | 4 | 1.5 |
| contact resistance rises sharply | | | | | | | |
| Overall evaluation | Bad | Unaccept- | Good | Excel- | Good | Unaccept- | Bad |
| | | able | | lent | | able | |

| | | | Sample No. | | | | | |
|---|---|---|---|---|---|---|---|---|
| | | | 8 | 9 | 10 | 11 | 12 | 13 |
| 30 | Plating | Thickness (μm) of | 0.05 | 0.1 | 0.2 | 0.3 | 0.5 | 1 |
| | structure | a second plating | | | | | | |
| | | layer (hardness: | | | | | | |
| | | 80) | | | | | | |
| | | Thickness (μm) of | 0.95 | 0.9 | 0.8 | 0.7 | 0.5 | 0 |
| | | a first plating layer | | | | | | |
| | | (hardness: 250) | | | | | | |

| | | | | | | |
|---|---|---|---|---|---|---|
| Contact resistance (mΩ) at the time | 145 | 42 | 34 | 35 | 305 | 1,000< |
| of 6,000 cycles of sliding | | | | | | |
| Wear depth (μm) at the time of 6,000 | 0.38 | 0.18 | 0.13 | 0.35 | 0.79 | 1 |
| cycles of sliding | | | | | | |
| Number of cycles (×1000) at which | 4 | 6 | 6 | 5 | 4 | 1 |
| contact resistance rises sharply | | | | | | |
| Overall evaluation | Unaccept- | Good | Excel- | Good | Unaccept- | Bad |
| | able | | lent | | able | |

TABLE 5

| Load | | | Sample No. | |
|---|---|---|---|---|
| (gf) | | | 14 | 15 |
| 30 | Plating | Thickness (μm) of a second | 0.2 | 0 |
| | structure | plating layer (hardness: 180) | | |
| | | Thickness (μm) of a first | 0.8 | 1 |
| | | plating layer (hardness: 330) | | |

| | | |
|---|---|---|
| Contact resistance (mΩ) at the time | 40 | 260 |
| of 6,000 cycles of sliding | | |
| Wear depth (μm) at the time of 6,000 | 0.15 | 0.4 |
| cycles of sliding | | |
| Number of cycles (×1000) at which | 6< | 4 |
| contact resistance rises sharply | | |
| Overall evaluation | Excellent | Bad |

| | | | Sample No. |
|---|---|---|---|
| | | | 16 |
| 30 | Plating | Thickness (μm) of a second plating layer | 0.2 |
| | structure | (hardness: 80) | |
| | | Thickness (μm) of a first plating layer | 0.8 |
| | | (hardness: 330) | |

| | |
|---|---|
| Contact resistance (mΩ) at the time of 6,000 cycles | 40 |
| of sliding | |
| Wear depth (μm) at the time of 6,000 cycles of | 0.2 |
| sliding | |
| Number of cycles (×1000) at which contact | 6 |
| resistance rises sharply | |
| Overall evaluation | Excellent |

It is possible to find from Tables 3 and 4 that when a plating structure is composed of only one layer of the second plating layer 6 and when a plating structure is composed of only one layer of the first plating layer 4, the plating structure has a high contact resistance value at 6,000 cycles of sliding and the number of cycles at which the contact resistance value rises sharply is small, resulting in unsuitable use of the plating structure as a contact terminal structure.

Further, in tables 3 and 4, when the thickness of the first plating layer 4 was P, and the thickness of the second plating layer 6 was Q, contact resistance values at 6,000 cycles of sliding were extremely low and the number of cycles at which the contact resistance values rises sharply was extremely great when Q/(P+Q) was 0.1, 0.2, or 0.3. Furthermore, when Q/(P+Q) was 0.2, contact resistance values at 6,000 cycles of sliding were the lowest in Table 4.

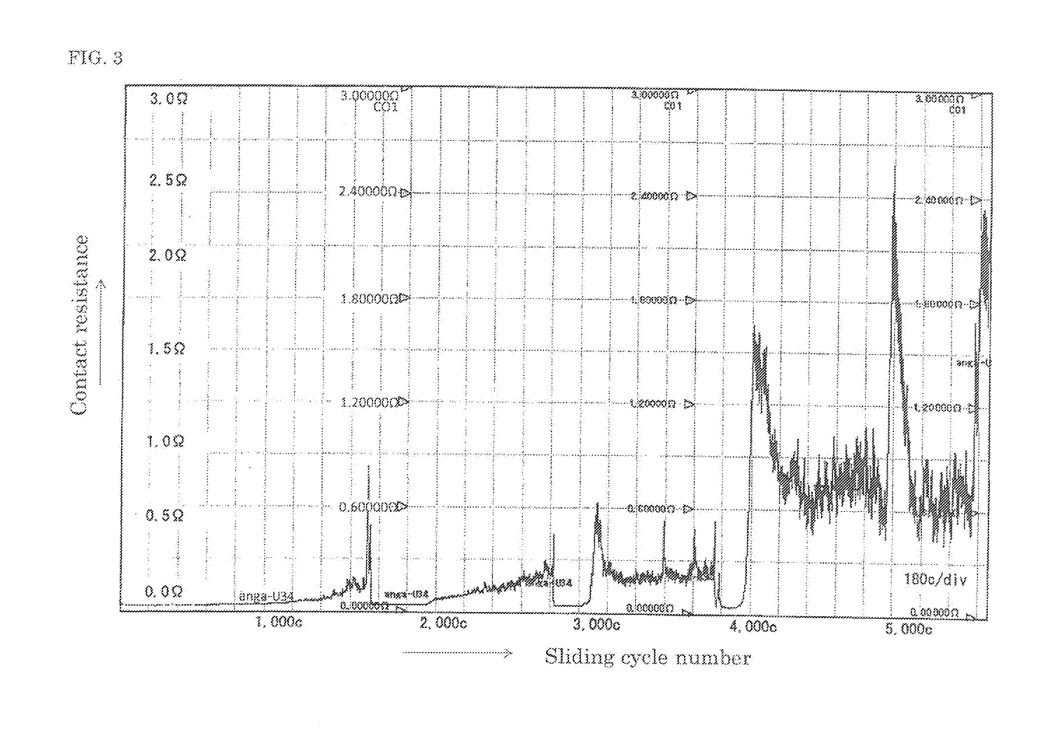

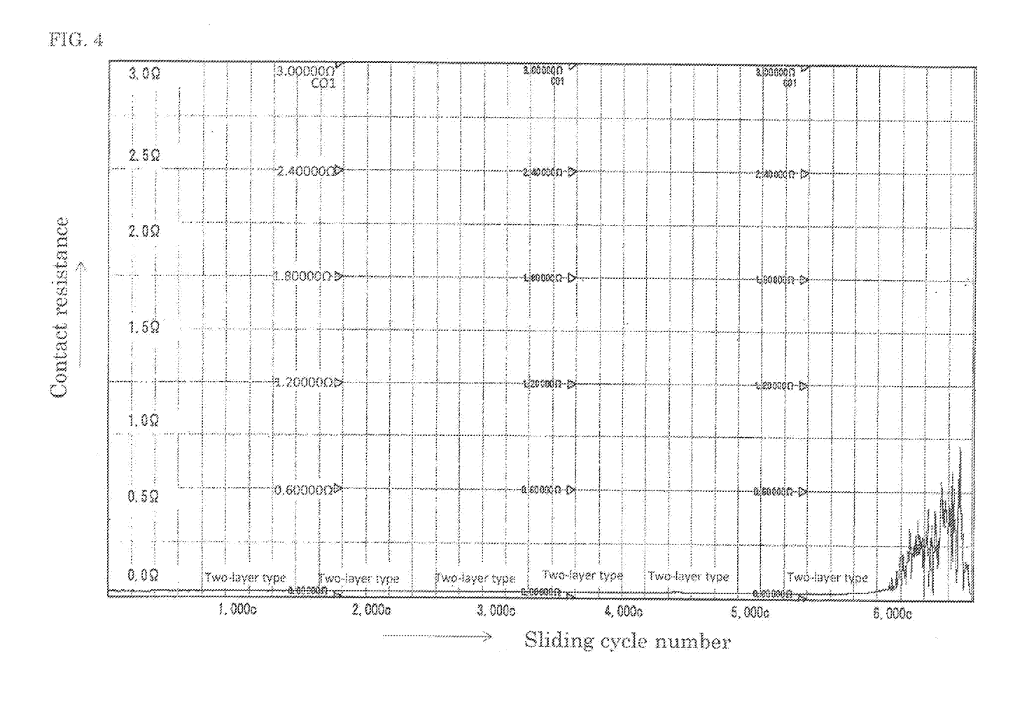

FIGS. 3 and 4 respectively show a typical chart obtained in measurement. FIG. 3 is a two-dimensional chart, in which a horizontal axis indicates sliding cycles in the case where load W: 30 gf, a plating structure: in the case of only a one-layer structure composed of the first plating layer 4 (hardness: 330) and a vertical axis indicates contact resistance values. FIG. 4 is a two-dimensional chart, in which load W: 30 gf, a plating structure: in the case of a two-layer structure (embodiments of the present invention) composed of the first plating layer 4 (hardness: 330, thickness: 0.8 μm) and the second plating layer 6 (hardness: 180, thickness: 0.2 μm), a horizontal axis indicates sliding cycles and a vertical axis indicates contact resistance values. While the contact resistance values rise sharply around 4,000 cycles of sliding cycles in FIG. 3, the contact resistance values little rise by near 6,000 cycles of sliding cycles in FIG. 4.

Next, film properties of plating were evaluated by using an insertion and removal tester. A female terminal was fixed and a male terminal was inserted and removed. Sliding was performed in a horizontal direction and a stroke was 14 mm, and one insertion and removal was performed for 6 seconds. The number of times of insertions and removals was set at 10,000 to 25,000 times. SFT-3200 produced by Seiko Instruments Inc. was used to measure the film thickness. A Micro Vickers hardness tester (Hardness tester MKV-G2 produced by Akashi Seisakusho) was used to measure hardness and the load was 10 gf.

Table 6 shows results of amounts of wear by inserting and removing. In the present invention, the first plating layer 4 composed of a silver-tin alloy had a hardness of 340 Hv, the second plating layer composed of silver had a hardness of 190 Hv. For comparison, two kinds of terminals (Ag—Sn 1, Ag—Sn 2) each having a plating layer composed of a silver-tin alloy only were prepared. Ag—Sn 1 had a hardness of 270 Hv. And Ag—Sn 2 had a hardness of 340 Hv. Ag—Sn 1 and Ag—Sn 2 were described in Japanese Patent Application Publication No. 2012-226994 A. In addition, a terminal having a plating layer composed of only silver was prepared. The hardness of the terminal was 190 Hv.

Four terminals were prepared for each kind of terminal to measure a thickness of each terminal and then was inserted and removed to measure the amount of wear. Table 6 shows the measurement results. In the present invention, the terminals do not easily become worn regardless of an increase in number of times of insertions and removals and the amount of wear was 4.9 μm when the number of times of insertions and removals was 25,000. The other terminals each had a greater amount of wear at each time than that of the present invention and the amount of wear of each of the terminals was 10 μm or greater when the number of times of insertions and removals was 25,000. It turned out that the plating films of the present invention did not easily become worn.

TABLE 6

| | | Number of (times) | | | |
|---|---|---|---|---|---|
| | | insertions and removals | | | |
| | | 10,000 | 15,000 | 20,000 | 25,000 |
| The present | Original film | 32 | 30 | 24 | 22 |
| invention | thickness (μm) | | | | |
| | Amount of wear | 1.5 | 0.1 | 3.8 | 4.9 |
| | (μm) | | | | |
| Ag—Sn 1 | Original film | 26 | 24 | 19 | 21 |
| | thickness (μm) | | | | |
| | Amount of wear | 3.0 | 3.8 | 8.6 | 10.5 |
| | (μm) | | | | |
| Ag—Sn 2 | Original film | 27 | 24 | 20 | 32 |
| | thickness (μm) | | | | |
| | Amount of | 2.5 | 2.9 | 8.0 | 22.3 |
| | wear (μm) | | | | |
| Silver only | Original film | 31 | 31 | 24 | 22 |
| | thickness (μm) | | | | |
| | Amount of wear | 7.3 | 8.2 | 12.6 | 16.9 |
| | (μm) | | | | |

Thicknesses of a remaining film were measured. As well as Table 6, four terminals for each kind of terminal were prepared to measure each film thickness and then measure the thickness of the remaining film only. Table 7 indicates the measurement results. In the present invention, a terminal had a film thickness of 15.1 μm even when the number of times of insertions and removals was 25,000. The other terminals each had a film thickness of 10 μm or smaller when the number of times of insertions and removals was 25,000, resulting in a great difference from the present invention. As a result, in the present invention, even when the time of insertions and removals of terminals increases, the films of the terminals remain and may endure use of a long period of time as terminals.

TABLE 7

| | | Number (times) of insertions and removals | | | |
|---|---|---|---|---|---|
| | | 10,000 | 15,000 | 20,000 | 25,000 |
| The present | Original film | 32 | 30 | 24 | 22 |
| invention | thickness | | | | |
| | (μm) | | | | |
| | Remaining film | 30.2 | 28.0 | 20.2 | 15.1 |
| | thickness (μm) | | | | |
| Ag—Sn 1 | Original film | 26 | 24 | 19 | 21 |
| | thickness (μm) | | | | |
| | Remaining film | 25.1 | 17.6 | 9.9 | 7.6 |
| | thickness (μm) | | | | |
| Ag—Sn 2 | Original film | 27 | 24 | 20 | 32 |
| | thickness (μm) | | | | |
| | Remaining film | 22.8 | 23.3 | 8.0 | 8.9 |
| | thickness (μm) | | | | |
| Silver only | Original film | 31 | 31 | 24 | 22 |
| | thickness (μm) | | | | |
| | Remaining film | 20.0 | 20.8 | 9.0 | 2.5 |
| | thickness (μm) | | | | |

An increase rate of each insertion force, removing force, and contact resistance was measured. The number of times of insertions and removals was 25,000 times and measurements were made at start time of insertions and removals and at finish time of insertions and removals. Table 8 shows the measurement results. In the present invention, insertion force and removal force is light and the increase rate of contact resistance is also low. In the present invention, it has turned out that inserting and removing is easy and uses in a long period of time may be possible.

TABLE 8

| | | | | Contact |
|---|---|---|---|---|
| | | | | resistance |
| | | Inserting | Removing | Increasing |
| | | force kgf | force kgf | rate (%) |
| The present | Start time of | 0.83 | 0.41 | — |
| invention | insertions and | | | |
| | removals | | | |
| | Finish time of | 0.75 | 0.29 | 1 |
| | insertions and | | | |
| | removals | | | |
| Ag—Sn 1 | Start time of | 0.82 | 0.45 | — |
| | insertions and | | | |
| | removals | | | |
| | Finish time of | 0.61 | 0.33 | 24 |
| | insertions and | | | |
| | removals | | | |
| Ag—Sn 2 | Start time of | 0.88 | 0.53 | — |
| | insertions and | | | |
| | removals | | | |
| | Finish time of | 0.63 | 0.32 | 47 |
| | insertions and | | | |
| | removals | | | |
| Silver only | Start time of | 1.71 | 1.08 | — |
| | insertions and | | | |
| | removals | | | |
| | Finish time of | 0.82 | 0.50 | 4 |
| | insertions and | | | |
| | removals | | | |

Residual amounts of silver contained in the second plating layer 6 of a male terminal and a female terminal having the contact terminal structure 1 of the present invention were measured. Table 9 shows results of the measurement. Even in the case where the plating structure is worn as a whole, a portion of silver remains, resulting in films that do not easily become worn.

TABLE 9

| Number of | | |
|---|---|---|
| insertions and | Female terminal | Male terminal |
| removals (times) | residual Ag (%) | residual Ag (%) |
| 0 | 100 | 100 |
| 10,000 | 3.3 | 2.0 |
| 20,000 | 2.4 | 1.2 |
| 25,000 | 2.6 | 1.2 |

Wear relative to a film of a terminal is adhesive wear. While metal has strong adhesiveness, metal has lower friction force by making shearing stress smaller. Friction force by shear is obtained by multiplying a contact area with the shearing stress (shear force for each unit area) and wear loss depends on friction force. When metal has lower friction force, wear loss decreases.

The reason for such experimental results will now be described by studying wear of metal that makes plastic contact with a hard spherical surface.

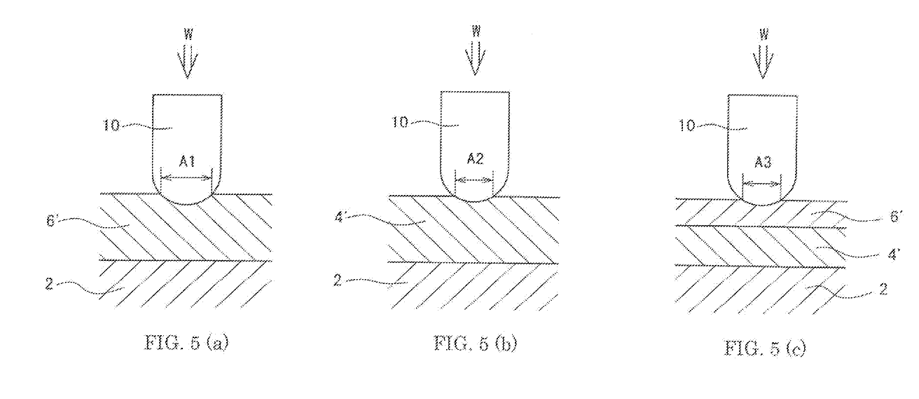

As shown in FIG. 5(a), the probe 10 with a spherical tip is pressed against a soft metal layer 6′ with a force of load W. A contact area of the probe 10 and the metal layer 6′ is A1. Shearing stress of the metal layer 6′ is S1. As shown in FIG. 5(b), the probe 10 with a spherical tip is pressed against a hard metal layer 4′ with a force of load W. A contact area of the probe 10 and the metal layer 4′ is A2. Shearing stress of the metal layer 4′ is S2. The contact area is A1>A2, and the shearing stress is S1<S2. When friction force is F1 in the case of FIG. 5(a) and when friction force is F2 in the case of FIG. 5(b), F1=A1S1, F2=A2S2. There is not great difference between both friction force F1 and F2 from the relation between the contact area and the shearing stress.

The structure like the present invention in which a hard metal layer 4′ is formed on a soft metal layer 6′ will now be explained. As shown in FIG. 5(c), the probe 10 with a spherical tip is pressed against a laminate composed of a hard metal layer 4′ and a soft metal layer 6′ with a force of load W. The hard metal layer 4′ is the first plating layer 4 of the present invention and the soft metal layer 6′ is the second plating layer 6 of the present invention. A contact area of the probe 10 and the metal layer 6′ is A3. In this case, since the hard metal layer 4′ supports the soft metal layer 6′, A1>A2=A3. Shearing stress in the case of FIG. 5(c) is S3. The shearing stress is S1=S3<S2 due to adhesion. Friction force F3 caused by shearing in the case of FIG. 5(c) is F3=A3S3=A2S1. Both the contact area and the shearing stress become smaller, so that F3<F1, F2.

Accordingly, in the present invention, the load W is supported by the hard metal layer 4′ and shearing by adhesion wear depends on the soft metal layer 6′, resulting in smaller friction force. Since the friction force becomes smaller, the wear loss becomes smaller.

Growth of wear and contact resistance not only affect on a surface layer but also is greatly influenced by a combination of a surface layer and a lower layer under the surface layer. On the other hand, the contact terminal structure, in which a silver-tin alloy is a surface layer, has relatively low contact resistance and durability. Accordingly, the contact terminal structure has superior performance as a material of a contact terminal.

In the present invention, the performance of the contact terminal structure is further improved in contact resistance and durability by further forming the second plating layer 6 on a surface of the first plating layer 4 that is a silver-tin alloy layer as mentioned above. In addition, the Vickers hardness of the second plating layer 6 is smaller than the Vickers hardness of the first plating layer 4 that is a lower layer thereof. That is, when the second plating layer 6 is softer than the first plating layer 4, as mentioned above, it has turned out that superior performance exerts.

The contact terminal structure of the present invention is preferably applicable to electric parts such as relays (for instance, relays for signal transmission, power relays for electric automobile), switches, connectors (for instance, connectors for signal transmission, connectors for general electric powers, charge connectors for electric automobiles), and breakers.

1. A contact terminal structure comprising:
a first plating layer formed on a surface of a substrate and composed of a silver tin alloy; and
a second plating layer formed on a surface of the first plating layer and essentially consisting of silver and an alloy including at least one kind of component selected from selenium and antimony,
the first plating layer having a Vickers hardness of 250 to 400 and the second plating layer having a Vickers hardness of 80 to 200.

2. The contact terminal structure according to claim 1, wherein
Q/(P+Q) is in the range of 0.07 to 0.4 where P is a thickness of the first plating layer and Q is a thickness of the second plating layer, and
the first and second plating layers each have a wear depth in the range of 1.5 μm to 3 μm when a probe is caused to slide at 6,000 cycles under a load of 300 gf against a plate on which the first plating layer and the second plating layer are formed with the second plating layer being formed on the first plating layer.

3. The contact terminal structure according to claim 1, wherein
Q/(P+Q) is in the range of 0.07 to 0.4 where P is a thickness of the first plating layer and Q is a thickness of the second plating layer, and
the first and second plating layers each have a wear depth in the range of 0.15 μm to 0.32 μm when a probe is caused to slide at 6,000 cycles under a load of 30 gf against a plate on which the first plating layer and the second plating layer are formed with the second plating layer being formed on the first plating layer.

4-6. (canceled)
